(19) United States
(12) Patent Application Publication
(10) Pub. No.: US 2010/0175000 A1
(43) Pub. Date: Jul. 8, 2010

(54) DYNAMICALLY CREATING AND MANAGING ALTERNATE CONTACTS LIST

(75) Inventors: Amit Gupta, Redmond, WA (US); Ginger Tien, Bellevue, WA (US); Alexander M. Hehmeyer, Bellevue, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/350,824

(22) Filed: Jan. 8, 2009

(51) Int. Cl. G06F 3/00

(52) U.S. Cl. 715/753

(57) ABSTRACT

Alternate contacts information for a subscriber is dynamically generated and managed by schematizing representation of alternate contacts. Initial alternate contacts are computed based on organization hierarchy, delegate information set by a user in system directory, contacts information set by the user in personal directories, and/or by other user defined settings. The information is customized by the user and associated with user presence such that a dynamic alternate contacts list is published to other users based on a presence status of the user.

### BACKGROUND

Modern communication systems have a large number of capabilities including integration of various communication modalities with different services. For example, instant messaging, voice/video communications, and other forms of communication may be combined with presence and availability information of subscribers. For enhanced communication, such systems may provide subscribers with the ability to provide instructions for various status categories. For example, one or more alternate contacts may be provided in an Out-Of-Office (OOF) message (voice or text).

However, conventional alternate contacts notifications are not user-friendly. For example, when a user is trying to reach a currently unavailable primary contact, they have to get the notification about the unavailability of the primary contact first, then to find an alternate contact to address their question. Typically, OOF notification and alternate contact information is stored in free form text, and it takes a user multiple steps to get to that before finally contacting an alternate contact. The sequence of steps may include setting and OOF note, sending an email to primary contact, receiving the OOF note in email, parsing the OOF note to find alternate contacts, and then contacting one of the alternate contacts.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to dynamically creating and managing alternate contacts information by schematizing representation of alternate contacts as well as computing the information from a variety of sources. According to some embodiments, alternate contacts may be computed based on organization hierarchy, delegates information set by a user in system directory, contacts information set by the user in personal directory(ies), or by other user defined settings. The information of alternate contacts may be relayed in a presence channel being coupled to a presence status of the user and provided to other users.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a diagram illustrating an example unified communications system, where embodiments may be implemented for exchange of alternate contact information;

FIG. 2 illustrates an example system where alternate contact information may be dynamically computed, customized, and disseminated according to some embodiments;

FIG. 3 is a conceptual diagram illustrating computation, customization, updating, and dissemination of alternate contact information according to embodiments;

FIG. 4 is a screenshot of an example subscriber contact card displaying alternate contact information;

FIG. 5 is a networked environment, where a system according to embodiments may be implemented;

FIG. 6 is a block diagram of an example computing operating environment, where embodiments may be implemented; and

FIG. 7 illustrates a logic flow diagram for dynamic generation and management of alternate contact information according to embodiments.

### DETAILED DESCRIPTION

As briefly described above, alternate contact information may be computed, customized, updated, and published based on a variety of sources. In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium can for example be implemented via one or more of a volatile computer memory, a non-volatile memory, a hard drive, a flash drive, a floppy disk, or a compact disk, and comparable media. The computer program product may also be a propagated signal on a carrier (e.g. a frequency or phase modulated signal) or medium readable by a computing system and encoding a computer program of instructions for executing a computer process.

Throughout this specification, the term “platform” may be a combination of software and hardware components for managing alternate contacts lists. Examples of platforms include, but are not limited to, a hosted service executed over a plurality of servers, an application executed on a single server, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below. Also, the term “dynamic” as used in conjunction with creation of alternate contacts is intended to illustrate the distinction between conventional approaches, where statically stored and managed information is used with rigid rules, and embodiments, which enable creation and updating of alternate contacts information based on frequently changing parameters such as subscriber presence.

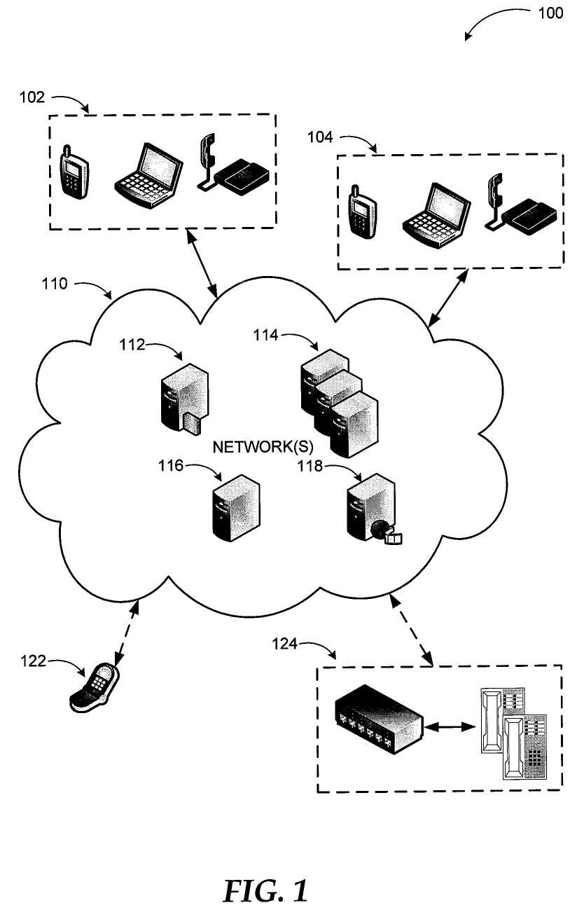

Referring to FIG. 1, diagram 100 of an example unified communications system, where embodiments may be practiced, is illustrated. A unified communication system is an example of modern communication systems with a wide range of capabilities and services that can be provided to subscribers. A unified communication system is a real-time communications system facilitating instant messaging, presence, audio-video conferencing, and web conferencing functionality.

In a unified communication (“UC”) system such as the one shown in diagram 100, users may communicate via a variety of end devices (102, 104), which are client devices of the UC system. Each client device may be capable of executing one or more communication applications for voice communication, video communication, instant messaging, application sharing, data sharing, and the like. In addition to their advanced functionality, the end devices may also facilitate traditional phone calls through an external connection such as through PBX 124 to a Public Switched Telephone Network (“PSTN”). End devices may include any type of smart phone, cellular phone, any computing device executing a communication application, a smart automobile console, and advanced phone devices with additional functionality.

UC Network(s) 110 includes a number of servers performing different tasks. For example, UC servers 114 provide registration, presence, and routing functionalities. Routing functionality enables the system to route calls to a user to anyone of the client devices assigned to the user based on default and/or user set policies. For example, if the user is not available through a regular phone, the call may be forwarded to the user's cellular phone, and if that is not answering a number of voicemail options may be utilized. Since the end devices can handle additional communication modes, UC servers 114 may provide access to these additional communication modes (e.g. instant messaging, video communication, etc.) through access server 112. Access server 112 resides in a perimeter network and enables connectivity through UC network(s) 110 with other users in one of the additional communication modes. UC servers 114 may include servers that perform combinations of the above described functionalities or specialized servers that only provide a particular functionality. For example, home servers providing presence functionality, routing servers providing routing functionality, and so on. Similarly, access server 112 may provide multiple functionalities such as firewall protection and connectivity, or only specific functionalities.

Audio/Video (A/V) conferencing server 118 provides audio and/or video conferencing capabilities by facilitating those over an internal or external network. Mediation server 116 mediates signaling and media to and from other types of networks such as a PSTN or a cellular network (e.g. calls through PBX 124 or from cellular phone 122). Mediation server 116 may also act as a Session Initiation Protocol (SIP) user agent (e.g. Back-to-Back User Agent “B2BUA”).

In a UC system, users may have one or more identities, which is not necessarily limited to a phone number. The identity may take any form depending on the integrated networks, such as a telephone number, a Session Initiation Protocol (SIP) Uniform Resource Identifier (URI), or any other identifier. While any protocol may be used in a UC system, SIP is a preferred method.

SIP is an application-layer control (signaling) protocol for creating, modifying, and terminating sessions with one or more participants. It can be used to create two-party, multiparty, or multicast sessions that include Internet telephone calls, multimedia distribution, and multimedia conferences. SIP is designed to be independent of the underlying transport layer.

SIP clients may use Transport Control Protocol (“TCP”) to connect to SIP servers and other SIP endpoints. SIP is primarily used in setting up and tearing down voice or video calls. However, it can be used in any application where session initiation is a requirement. These include event subscription and notification, terminal mobility, and so on. Voice and/or video communications are typically done over separate session protocols, typically Real Time Protocol (“RTP”).

Alternate contact information may be initially computed based on information from a directory server storing static contact information, a communications server providing organizational information, and/or a personal address book of a subscriber. The subscriber may be enabled to customize the initial computation results. One of the UC servers 114 described above acting as a presence server may store the customized and updated alternate contact information and with input from the subscriber regarding their presence status, enable publication of the alternate contacts list based on the presence status. More detailed examples are discussed below.

While the example system in FIG. 1 has been described with specific components such as mediation server, A/V server, and similar devices, embodiments are not limited to these components or system configurations and can be implemented with other system configuration employing fewer or additional components. Functionality of systems computing alternate contacts information based on a variety of sources may also be distributed among the components of the systems differently depending on component capabilities and system configurations. Furthermore, embodiments are not limited to unified communication systems. The approaches discussed here may be applied to any data exchange in a networked communication environment using the principles described herein

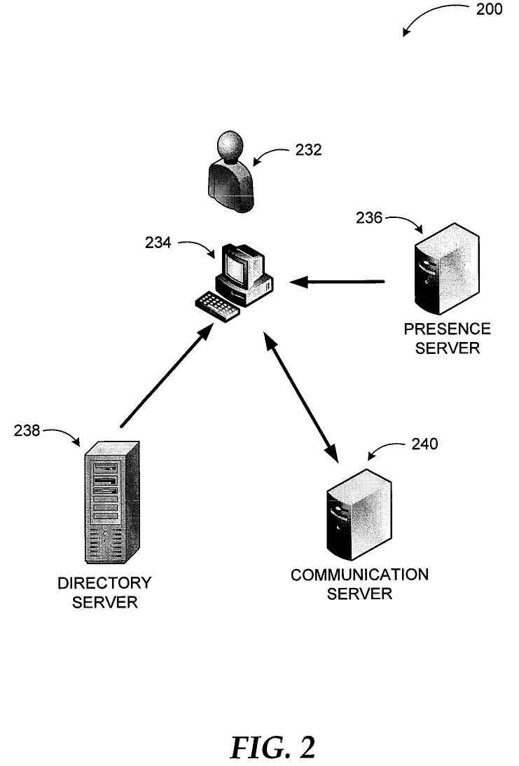

FIG. 2 illustrates an example system 200, where alternate contact information may be dynamically computed, customized, and disseminated according to some embodiments. While a system according to embodiments is likely to include a number of servers and services such as those illustratively discussed in FIG. 1, only those relevant to embodiments are shown in FIG. 2.

Alternate contacts list for subscriber 232 may first be computed based on information from a variety of sources such as organizational contacts information from directory server 238. This information is typically static, and may include organizational hierarchy, functional hierarchy, addresses, phone numbers, titles, and similar information for contacts. Other directories such as various address books maintained by servers like communication server 240 (e.g. personal address book associated with an email application) may be used as information source as well.

The initial alternate contacts list may then be provided to subscriber 232 through client device 234 for selection of alternate contacts and customization of the information. To accomplish this efficiently, a schema may be defined for alternate contacts associating them with subscriber status(es). The schema may include basic attributes like name and/or alias for the alternate contact, a description of the contact category. The schema may include additional attributes such as a relationship of a particular alternate contact to the subscriber and/or other alternate contacts, time of availability for the alternate contacts, and similar information. Subscriber 232 may select a subset of the alternate contacts for a particular status (e.g. OOF), customize their attributes (or keep default values). The customized and updated alternate contacts list may then be associated with the subscriber's presence through presence server 236 and published to other subscribers as part of the subscriber 232's presence through communication server 240. For example, if the subscriber 232 is OOF, the alternate contacts designated for OOF status may be provide to other subscribers.

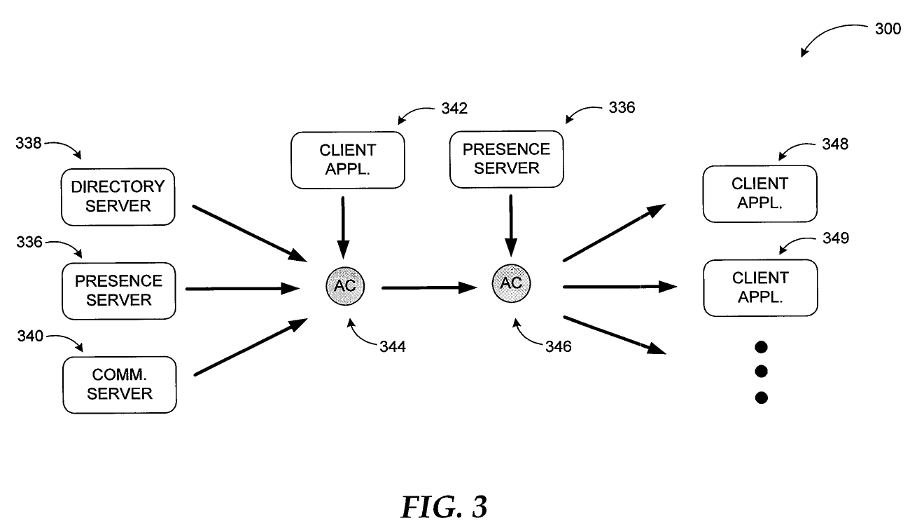

FIG. 3 is a conceptual diagram 300 illustrating computation, customization, updating, and dissemination of alternate contact information according to embodiments. Alternate contacts information may be provided by a variety of sources and aggregated according to a predefined schema.

Directory server 338 manages typically static information 356 such as organizational hierarchy, title, office/home/email addresses, photo, and other similar data. These types of information do not change frequently and can be managed by an organizational service based on organization level rules (access, security, update, etc. rules). Another information source is communication server 340 providing delegates information set by the user, team information set by the user or an administrator, and similar information. Presence server 336 may also provide information regarding default attributes of initial alternate contacts. The aggregated alternate contact information 344 is presented to the subscriber through client application 342 for selection of alternate contacts from the aggregated list and customization of default attributes such as names, aliases, contact descriptions, roles, and the like. The selected and customized alternate contacts group 346 may be stored by communication server 340 as a special group for the subscriber.

According to one embodiment, a distinct alternative contacts group may be set for a number of default or user-defined statuses (e.g. out of office, temporarily unavailable, prolonged unavailability, and comparable ones). The alternate contacts group 346 defined according to the schema may be associated with a corresponding presence status through presence server 336 and published to client applications 348, 349, etc. when the corresponding presence status is active (e.g. OOF). The alternate contact information may be published through a live contact card to the other users.

Subscribers may also be enabled to configure the alternate contacts always to be displayed on their contact card, so other subscribers can contact the alternate contacts when it is hard to reach the primary contact. The display of alternate contacts on subscriber's contact card further enables a caller to find them before starting a communication session.

It should be noted that presence is not the only mechanism for communicating the alternate contact data, it is simply one option. Another example mechanism, according to embodiments, may be the contact store itself. Conceptually, a system according to one embodiment may comprise three major components: (1) publisher computation of alternate contacts (the publisher auto-computes, manually sets and gathers data regarding their alternate contacts); (2) channel to communicate alternate contacts (e.g. a presence server or a contact server acting as transport mechanism to get the data from the publisher to the watcher); and (3) watcher computation of alternate contacts (the entity watching may further compute what to actually display). Some example channels may include the presence server, the contact server, and the email server (e.g. when sending an OOF email response).

It should also be noted that alternate contacts may be used in cases other than when the user is OOF. Some examples include when the publisher is offline, “Do Not Disturb”, “Busy”, or “Away” statuses. Some example scenarios for utilizing alternate contacts may be listed as:

1. Availability
i. Offline
ii. Out of Office
iii. Away
iv. Do Not Disturb or Busy

2. Location
i. Home
ii. Office
iii. Business Travel

3. Capabilities
i. e.g., cannot do application sharing but watcher wants to share a document

While embodiments are described with reference to “alternate contacts”, this term should not be construed as being limited to a contacts list in context of an email or calendaring application. Alternate contacts, as used herein, refers to a broader understanding about letting others know who is in the user's social network. For example, the alternate contact information may be utilized in conjunction with “expert search” or “knowledge base” (a user trying to find an “expert” who is related to them or someone they know). Another example utilization area is “social awareness” and “team building” (i.e. having a sense of who someone is working with regularly can spur impromptu conversations and facilitate better collaboration, particularly across groups). Users may wish to reveal more presence data to colleagues of their colleagues than to others in their enterprise generally.

Furthermore, embodiments may be implemented within “team call” or “call delegation” areas built in to unified communication systems. In general, anyone in the user's social network may be automatically routed based on a set of rules. In a strict sense of “alternate contacts” usage, routing may be manual, where the sender decides what to do based on information given to them. However, embodiments enable automatic routing based on the principles described herein.

According to some embodiments, communication enabled endpoints may employ alternate contact information to perform rule based and/or system defined tasks such as: (1) a publisher may set the rules to direct calls to alternate contacts in a particular order of availability including routing of other communication modalities like voice, instant message, video, etc.; (2) the routing rules may be tied to alternate contacts based on the user's presence availability; (3) a system may notify a caller that the called party's communication is routed and the caller may decide to control the call (e.g. cancel); (4) some devices may read the contact presence and provide notification to the user before the call is established (e.g. “the caller is not available and you may want to reach alternate contacts”); (5) alternate contacts may also be used to set delegation information (e.g. using the alternate contact schema one may define who their delegate is to manage their communication while they are unavailable.

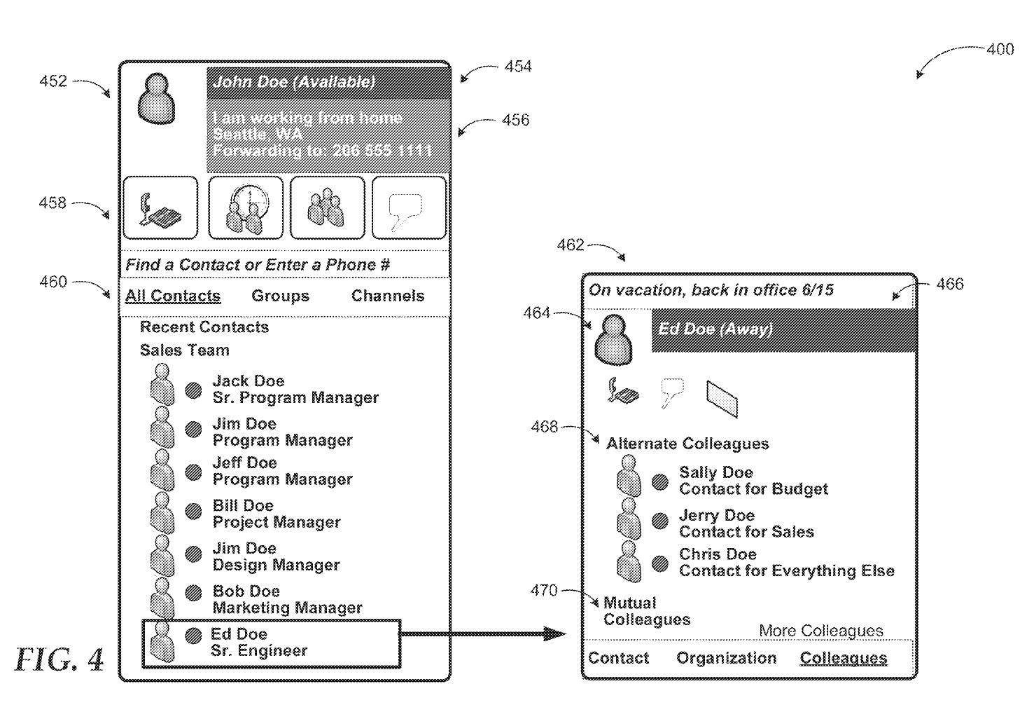

FIG. 4 is a screenshot 400 of an example subscriber contact card displaying alternate contact information. While alternate contact information aggregated as described above may be utilized by a number of applications to perform actions based on the information (scheduling, organizational analysis, etc.), a prominent use environment for alternate contact lists according to some embodiments is displaying them on communication application user interfaces.

Example subscriber contact card 452 is for John Doe whose picture and status (available) are shown (454) prominently at the top portion of the card. Further status information (working from home, city, and call forwarding information) 456 are shown at the upper portion of the card. This is followed by graphical icons 458 for activating various communication modes (e.g. phone call, conference call, text messaging, etc.). A lower portion 460 of the contact card 452 includes a listing of John Doe's sales team contacts. Each contact is represented by their picture, name, and title. The contacts are identified as a special group (Sales Team). As shown in the figure, the selection of one of the contacts (Ed Doe) may result in display of an alternate contact card for this subscriber on the user interface.

The contact card 462 for Ed Doe is similar to the contact card 452 in some aspects. For example, the subscriber's status, picture and name are displayed at upper portions 464 and 466 of the contact card, albeit in a slightly different configuration. Since Ed Doe's status is “away”, the contacts list 468 displayed prominently on his contact card is Ed's alternate contacts identified by their pictures, names, and contact categories. This information enables another subscriber to determine an appropriate subscriber to call instead of Ed during Ed's absence and initiate communication directly with that subscriber instead of contacting Ed first, getting an “away” notification, etc. As mentioned previously, a contact card according to embodiments may include other attributes such as relationships of the contacts to others (e.g. Mutual Colleagues 470).

Subscriber information combined in a subscriber contact card may be used by a number of applications directly (displaying the card) or indirectly (consuming the data) such as communication applications, electronic mail applications, calendar applications, scheduling applications, word processing applications, spreadsheet applications, database applications, and comparable ones. The applications may be local applications or distributed services executed by a central server and accessed through a browser or similar application.

The above discussed scenarios, example systems, cards, or applications are for illustration purposes. Embodiments are not restricted to those examples. Other forms of subscriber data, contact cards, and applications may be used in implementing aggregation of alternate contact information in a similar manner using the principles described herein.

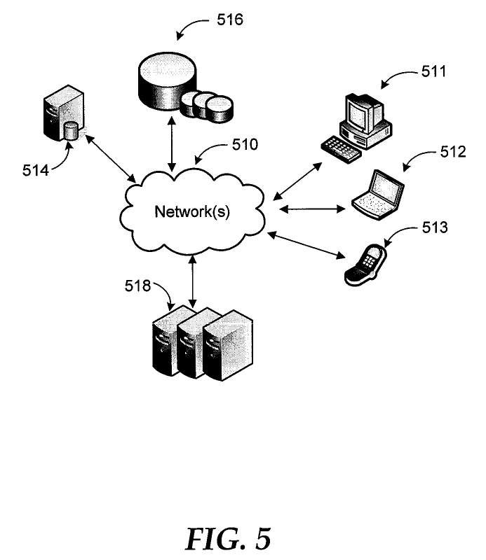

FIG. 5 is an example networked environment, where embodiments may be implemented. A platform providing communication services may be implemented via software executed over one or more servers 518 such as a hosted service. The platform may communicate with client applications on individual computing devices such as a cellular phone 513, a laptop computer 512, and desktop computer 511 (client devices) through network(s) 510.

As discussed above, modern communication technologies such as UC services enable subscribers to utilize a wide range of computing device and application capabilities in conjunction with communication services. This means, a subscriber may use one or more devices (e.g. a regular phone, a smart phone, a computer, a smart automobile console, etc.) to facilitate communications. Depending on the capabilities of each device and applications available on each device, additional services may be enabled in conjunction with the available communications. Furthermore, subscribers are also provided presence information including location, contact information, alternative contacts, availability status, calendar information, and similar data that may be used in determining whether or not to initiate communication with a subscriber, which mode of communication, and similar decisions.

As discussed previously, client devices 511-513 are used to facilitate communications through a variety of modes between subscribers of the communication system. Presence information and other data are provided to the client applications along with dynamic alternate contacts information in a subscriber contact card. Thus, alternate contact information generated from a directory server, organizational and personal contact lists, hierarchies, and comparable sources may be aggregated and forwarded to client applications being executed client devices 511-513. Upon customization by a subscriber, the alternate contact information may be associated with presence information for the subscriber and optionally with presence information of alternate contacts, and provide to other users of the communication system. Information associated with subscribers and facilitating communications such as presence information may be stored in one or more data stores (e.g. data store 516), which may be managed by any one of the servers 518 or by database server 514.

Network(s) 510 may comprise any topology of servers, clients, Internet service providers, and communication media. A system according to embodiments may have a static or dynamic topology. Network(s) 510 may include a secure network such as an enterprise network, an unsecure network such as a wireless open network, or the Internet. Network(s) 510 may also coordinate communication over other networks such as PSTN or cellular networks. Network(s) 510 provides communication between the nodes described herein. By way of example, and not limitation, network(s) 510 may include wireless media such as acoustic, RF, infrared and other wireless media.

Many other configurations of computing devices, applications, data sources, and data distribution systems may be employed to implement a system for generating, updating, and managing alternate contact information. Furthermore, the networked environments discussed in FIG. 5 are for illustration purposes only. Embodiments are not limited to the example applications, modules, or processes.

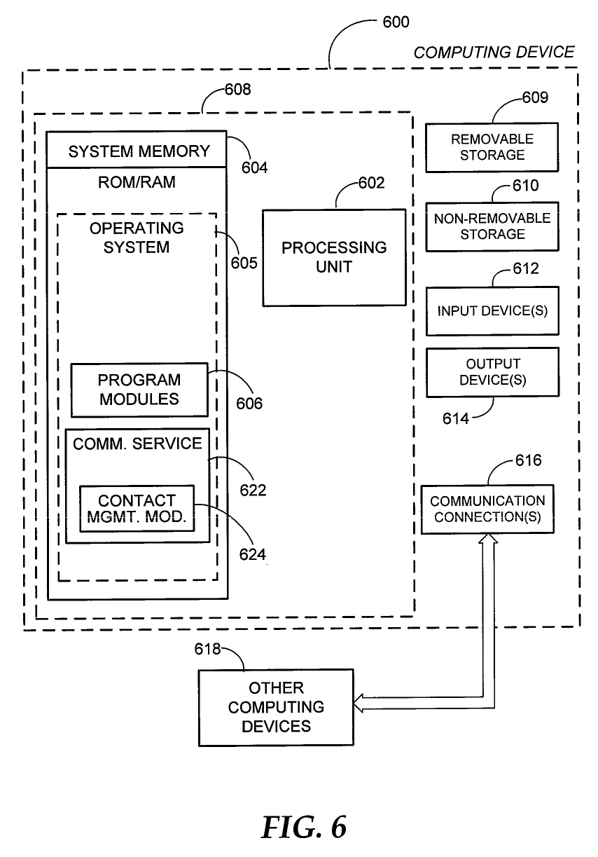

FIG. 6 and the associated discussion are intended to provide a brief, general description of a suitable computing environment in which embodiments may be implemented. With reference to FIG. 6, a block diagram of an example computing operating environment for an application according to embodiments is illustrated, such as computing device 600. In a basic configuration, computing device 600 may be a communication server or another server for managing alternate contact information and include at least one processing unit 602 and system memory 604. Computing device 600 may also include a plurality of processing units that cooperate in executing programs. Depending on the exact configuration and type of computing device, the system memory 604 may be volatile (such as RAM), non-volatile (such as ROM, flash memory, etc.) or some combination of the two. System memory 604 typically includes an operating system 605 suitable for controlling the operation of the platform, such as the WINDOWS® operating systems from MICROSOFT CORPORATION of Redmond, Wash. The system memory 604 may also include one or more software applications such as program modules 606, communication application 622, and contact management module 624.

Communication application 622 may be any application that facilitates communication between client applications and servers relevant to an enhanced communication system such as presence servers. Contact management module 624 may receive alternate contact related information from a variety of sources such as a directory server, client device, and so on, and generate a dynamically updateable alternate contact list as discussed previously. Contact management module 624 and application 622 may be separate applications or integral modules of a hosted service that provides enhanced communication services to client applications/devices. This basic configuration is illustrated in FIG. 6 by those components within dashed line 608.

Computing device 600 may have additional features or functionality. For example, the computing device 600 may also include additional data storage devices (removable and/or non-removable) such as, for example, magnetic disks, optical disks, or tape. Such additional storage is illustrated in FIG. 6 by removable storage 609 and non-removable storage 610. Computer readable storage media may include volatile and nonvolatile, removable and non-removable media implemented in any method or technology for storage of information, such as computer readable instructions, data structures, program modules, or other data. System memory 604, removable storage 609 and non-removable storage 610 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 600. Any such computer readable storage media may be part of computing device 600. Computing device 600 may also have input device(s) 612 such as keyboard, mouse, pen, voice input device, touch input device, and comparable input devices. Output device(s) 614 such as a display, speakers, printer, and other types of output devices may also be included. These devices are well known in the art and need not be discussed at length here.

Computing device 600 may also contain communication connections 616 that allow the device to communicate with other devices 618, such as over a wireless network in a distributed computing environment, a satellite link, a cellular link, and comparable mechanisms. Other devices 618 may include computer device(s) that execute communication applications, other directory or presence servers, and comparable devices. Communication connection(s) 616 is one example of communication media. Communication media can include therein computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

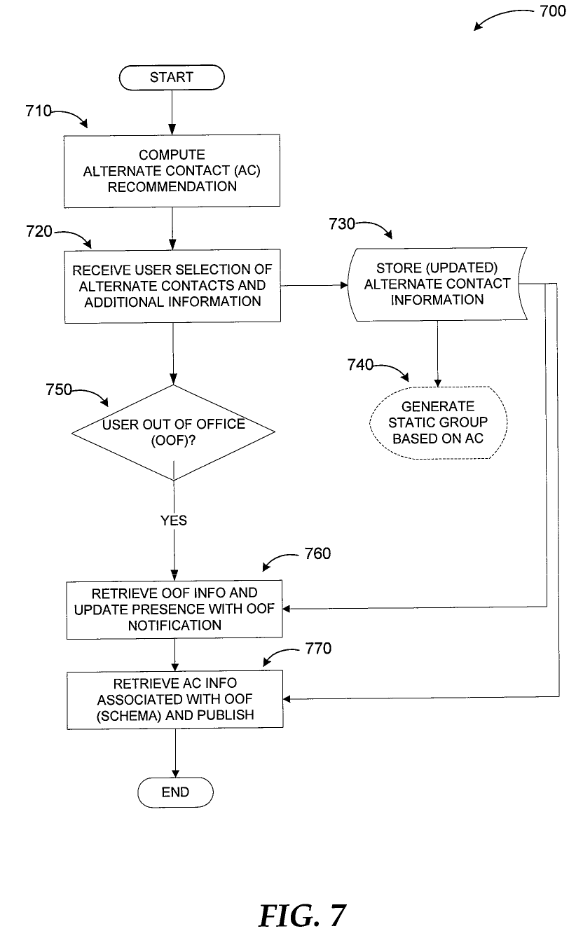

FIG. 7 illustrates a logic flow diagram 700 for generating and managing alternate contact information according to embodiments. Process 700 may be implemented as part of an enhanced communication system that includes exchange of presence information about subscribers.

Process 700 begins with operation 710, where alternate contact recommendation is computed for a subscriber based on a number of information sources such as an organizational hierarchy, organizational directory information, personal directory information, other pre-configured contacts lists, and comparable data. At operation 720 following operation 710, a user selection of alternate contacts from the recommendation and additional custom information from the user is received. The additional information may include attributes for alternate contacts such as their roles, priority levels, and similar characteristics. Some of this information may also be pre-configured in the information sources used at operation 710.

From operation 720, processing branches out to separate paths. One of the paths includes operation 730, where the customized and/or updated alternate contacts list is stored and coupled with a subscriber status schema (e.g. an OOF schema). A static group of contacts may be generated from the stored alternate contacts list at optional operation 740 for display in the subscriber's contact list as the current alternate contacts list. The subscriber may use this visual feedback in future updates/customizations of their alternate contacts list.

Also following operation 720, a determination is made whether the user is out of office at decision operation 750. Out Of Office (OOF) is one example status for the subscriber, where the alternate contacts list may be utilized. Embodiments are not limited to OOF scenarios, however. Alternate contacts lists may be generated/updated for a number of different presence statuses and used as discussed herein. If the user is OOF (or in a predefined presence status), the OOF information is retrieved and presence for the subscriber updated with OOF notification at operation 760. Subsequently, alternate contacts information associated with the OOF status may be retrieved (as defined by the OOF schema) and published as part of the presence information for the subscriber such that other subscribers of the system can be provided up-to-date and actionable alternate contact information such as those discussed in conjunction with FIG. 4.

The operations included in process 700 are for illustration purposes. Dynamically generating and managing alternate contact information in a subscriber contact card may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to be executed at least in part in a computing device for managing alternate contact information, the method comprising:
receiving contact information associated with a subscriber from a plurality of sources;
determining an initial alternate contact list by aggregating the received contact information according to a predefined schema;
enabling the subscriber to modify the initial alternate contact list;
determining a presence status of the subscriber; and
publishing the modified alternate contact list as part of the subscriber's contact card based on the subscriber's presence status.

2. The method of claim 1, wherein enabling the subscriber to modify the initial alternate contact list includes:
enabling the subscriber to select and prioritize contacts from the initial alternate contact list; and
enabling the subscriber to modify information associated with the selected contacts according to the predefined schema.

3. The method of claim 1, further comprising:
enabling the subscriber to define access parameters associated with the published alternate contact list.

4. The method of claim 1, wherein received contact information includes information associated with at least one from a set of: an organizational directory, a personal directory, a custom directory.

5. The method of claim 1, wherein the received contact information is aggregated based on at least one from a set of: an organizational hierarchy, a functional hierarchy, an organization policy, and a category of contacts.

6. The method of claim 1, further comprising:
prioritizing the initial alternate contact list based on a presence status of individual contacts on the initial alternate contact list.

7. The method of claim 1, wherein dynamic information associated with each contact in the published alternate contact list is provided to recipients of the subscriber's contact card through a presence channel.

8. The method of claim 1, further comprising:
enabling a recipient application to display the alternate contact list as part of the subscriber's contact card, wherein the recipient application is further enabled to display a contact card of a selected alternate contact in response to selection of that alternate contact.

9. The method of claim 8, wherein contact card of the selected alternate contact includes another alternate contact list associated with the selected alternate contact.

10. The method of claim 1, wherein the presence status includes at least one from a set of: available, unavailable, temporarily unavailable, offline, away, busy, and out of office.

11. The method of claim 10, wherein a recipient application is enabled to one of:
display the alternate contact list as part of the subscriber's contact card if the presence status is other than available;
direct calls for the subscriber to alternate contacts in a predefined order of availability of other communication modalities;
notify a caller that the subscriber's communication is routed; and
define delegation information for the subscriber.

12. The method of claim 1, further comprising:
enabling the subscriber to generate a plurality of alternate contact lists each alternate contact list being associated with a distinct presence status; and
enabling a recipient application to display an alternate contact list corresponding to a current presence status of the subscriber as part of the subscriber's contact card.

13. A communication system for managing alternate contact information, the system comprising:
a first server configured to:
receive contact information associated with a subscriber from a plurality of sources;
aggregate the received contact information to an initial alternate contact list according to a predefined schema;
enable the subscriber to modify the initial alternate contact list by at least one of:
selecting contacts from the initial alternate contact list,
prioritizing the selected contacts, and
modifying information associated with the prioritized contacts according to the predefined schema; and
a second server configured to:
determine a presence status of the subscriber and the prioritized contacts; and
publish the modified alternate contact list as part of the subscriber's contact card based on the subscriber's and the prioritized contacts' presence status.

14. The system of claim 13, wherein the predefined schema includes at least one contact attribute from a set of: a name, an alias, a contact description, a contact role, and contact availability.

15. The system of claim 13, wherein the contact information includes at least one from a set of: an address, an organization, an email address, a phone number, an image associated with the contact; an organizational hierarchy; delegates information defined by the subscriber; and team information defined by an administrator.

16. The system of claim 13, wherein the received contact information is further aggregated based on organization level rules associated with at least one from a set of: access control, security, and update frequency.

17. A computer-readable storage medium with instructions stored thereon for managing alternate contact information, the instructions comprising:
receiving contact information associated with a subscriber from a plurality of servers managing at least one from a set of: an organizational directory, a personal directory, a custom directory;
determining a contact list by aggregating the received contact information according to a predefined schema based on organization level rules associated with at least one from a set of: access control, security, and update frequency;
generating an alternate contact list for the subscriber from the contact list by:
automatically selecting and prioritizing contacts from the contact list based on at least one of subscriber defined and system defined rules; and
enabling the subscriber to modify attributes associated with the selected contacts according to the predefined schema;
determining a presence status of the subscriber; and
publishing the alternate contact list as part of the subscriber's contact card based on the subscriber's presence status, wherein dynamic information associated with each contact in the published alternate contact list is provided to recipients of the subscriber's contact card.

18. The computer-readable medium of claim 17, wherein the alternate contact list is presented to recipient applications even when the presence status of the subscriber is available.

19. The computer-readable medium of claim 17, wherein the alternate contact list is re-prioritized based on each contact's presence status.

20. The computer-readable medium of claim 17, wherein the alternate contact list is configured so that another alternate contact list for a selected contact is presented to a recipient application depending on the contact's presence status.
